(19) United States
(12) Patent Application Publication
(10) Pub. No.: US 2015/0302987 A1
(43) Pub. Date: Oct. 22, 2015

(54) PRODUCTION METHOD FOR COIL ELEMENT, COIL ELEMENT ASSEMBLY, AND COIL COMPONENT

(71) Applicant: LEAP CO., LTD, Kanagawa (JP)

(72) Inventors: Takashi SANO, Kanagawa (JP); Tokinori TERADA, Kanagawa (JP)

(73) Assignee: LEAP CO., LTD., Kanagawa (JP)

(21) Appl. No.: 14/438,994

(22) PCT Filed: Oct. 30, 2012
(86) PCT No.: PCT/JP2012/006958

§ 371 Date: Apr. 28, 2015

(51) Int. Cl. H01F 41/04

(52) U.S. Cl. CPC H01F 41/04

(57) ABSTRACT

A method for producing a coil element includes preparing a transfer mold having an inverse coil element pattern etched thereon, forming a peel-away film and an insulating film on the surface of the transfer mold in a superimposed manner, forming a resist film in an area having no inverse coil element pattern formed therein on the insulating film, removing by etching the insulating film with the resist film as a mask, after removing the resist film, filling up an area having the inverse coil element pattern formed therein and forming a central conductive film by first electroplating so as to slightly protrude above the insulating film, peeling the central conductive film from the transfer mold, and forming a surface conductive film by second electroplating with the central conductive film as a foundation and forming a coil element comprised of the central conductive film and the surface conductive film.

### CROSS-REFERENCE TO RELATED APPLICATION

This application is the National Stage of International Application No. PCT/JP2012/006958 having International filing date 30 Oct. 2012, which designated the United States of America, and which International Application was published under PCT Article 21 (s) as WO Publication 2014/068611 A1 the disclosures of which are incorporated herein by reference in their entireties.

### BACKGROUND

The presently disclosed embodiment relates to a method for producing a coil component by using a transfer mold, and more specifically to a production method for a coil element using a transfer mold, a coil element assembly using a transfer mold substrate, and a coil component using the coil element assembly.

With the multi-functionalization of mobile devices such as recent smart phones and tablet terminals, the need for a coil component (inductor) which is small in size and capable of handling a high rated current is increasing. As a production method for such a coil component, there has been described in Japanese Patent Application Laid-Open No. 2001-267166 that an underlying conductive layer is formed on an insulating substrate, a resist pattern is spirally formed on the surface of the underlying conductive layer, and a center conductor substantially rectangular in cross-section is formed by performing first electroplating with the underlying conductive layer as a base, and after peeling the resist pattern, the center conductor is thickened by performing second electroplating with the center conductor as a base to produce a planar coil.

Further, the need for a coil component having a so-called high aspect conductor pattern which is narrow in coil pattern width and large in thickness is also high. As a production method for such a coil component, there has been described in Japanese Patent Application Laid-Open No. H11-204361 a technique that a photoresist between conductor patterns is additionally removed by active ray irradiation after plating treatment, using a positive photoresist, and while maintaining a protective thin film layer applied on coil conductors formed by plating, a plating underlying thin film layer between the coil conductors is selectively removed, whereby a plurality of high aspect conductor patterns narrow in width and large in thickness are provided in parallel at narrow intervals.

### SUMMARY

In the methods for producing the coil components by the aforementioned related arts, any of the coil components is formed on the insulating substrate. After the formation of the coil component, the insulating substrate could not be removed. Therefore, when a magnetic core material is inserted into a coil center portion after the formation of the coil component to achieve high inductance, there was only provided an opening in the insulating substrate or inserted a core material only from one surface of the insulating substrate.

As a result of repeated intensive studies by the inventors of the presently disclosed embodiment, a finding can be obtained that the coil component can be produced without using the insulating substrate by using a transfer mold, thus leading to the completion of the presently disclosed embodiment.

The above problems can be achieved by the following presently disclosed embodiment. A first aspect of the presently disclosed embodiment relates to a method for producing a coil element using a transfer mold of which at least a surface portion is made of metal, and has a step of preparing the transfer mold having an inverse coil element pattern etched in the surface portion, a step of forming a peel-away film and an insulating film on the surface of the transfer mold in a superimposed manner, a step of forming a resist film in an area having no inverse coil element pattern formed therein on the insulating film, a step of removing by etching the insulating film with the resist film as a mask, a step of after removing the resist film, filling up an area having the inverse coil element pattern formed therein and forming a central conductive film by first electroplating so as to slightly protrude above the insulating film, a step of peeling the central conductive film from the transfer mold and taking out only the central conductive film, and a step of forming a surface conductive film by second electroplating with the taken-out central conductive film as a foundation and forming a coil element comprised of the central conductive film and the surface conductive film.

A second aspect of the presently disclosed embodiment relates to a method for producing a coil element using a transfer mold of which at least a surface portion is made of metal, and has a step of preparing the transfer mold having an inverse coil element pattern etched in the surface portion, a step of forming a peel-away film and an insulating film on the surface of the transfer mold in a superimposed manner, a step of forming a resist film in an area having no inverse coil element pattern formed therein on the insulting film, a step of removing by etching the insulating film with the resist film as a mask, a step of after removing the resist film, filling an area having the inverse coil element pattern formed therein and forming a central conductive film by first electroplating so as to remain in the insulating film, a step of after removing the insulating film, peeling the central conductive film from the transfer mold, and taking out only the central conductive film, and a step of forming a surface conductive film by second electroplating with the taken-out central conductive film as a foundation and forming a coil element comprised of the central conductive film and the surface conductive film.

A third aspect of the presently disclosed embodiment relates to a method for producing a coil element using a transfer mold of which at least a surface portion is made of metal, and has a step of preparing the transfer mold having an inverse coil element pattern etched in the surface portion, a step of forming a peel-away film and an insulating film on the surface of the transfer mold in a superimposed manner, a step of forming a resist film in an area having no inverse coil element pattern formed therein on the insulating film, a step of removing by etching the insulating film with the resist film as a mask, a step of after removing the resist film, filling an area having the inverse coil element pattern formed therein and forming a central conductive film by first electroplating so as to remain in the transfer mold, a step of peeling the central conductive film from the transfer mold and taking out only the central conductive film, and a step of forming a surface conductive film by second electroplating with the taken-out central conductive film as a foundation and forming a coil element comprised of the central conductive film and the surface conductive film.

A fourth aspect of the presently disclosed embodiment relates to a method for producing a coil element using a transfer mold of which at least a surface portion is made of metal, and has a step of preparing the transfer mold, having an inverse coil element pattern etched in the surface portion, a step of forming a peel-away film and an insulating film on the surface of the transfer mold in a superimposed manner, a step of forming a resist film in an area having no inverse coil element pattern formed therein on the insulating film, a step of removing by etching the insulating film with the resist film as a mask, a step of filling up an area having the inverse coil element pattern formed therein and forming a central conductive film by first electroplating so as to remain in the resist film, a step of after removing the resist film, peeling the central conductive film from the transfer mold and taking out only the central conductive film, and a step of forming a surface conductive film by second electroplating with the taken-out central conductive film as a foundation and forming a coil element comprised of the central conductive film and the surface conductive film.

In the first aspect, the end of the central conductive film, which slightly protrudes above the insulating film, is removed by electrolytic reverse plating treatment.

Also, in the third aspect, the peeling of the central conductive film from the transfer mold is performed by forming a release agent film on the insulating film, depositing an adhesive film so as to cover the exposed surface of the central conductive film and the release agent film, and peeling the central conductive film from the transfer mold together with the adhesive film, and thereafter removing the adhesive film.

In the third aspect, the peeling of the central conducive film from the transfer mold is performed by depositing a metal film so as to cover the exposed surface of the central conductive film and the insulating film and peeling the central conductive film from the transfer mold together with the metal film, and thereafter removing the metal film.

Further, in the third aspect, the release agent film is silicone or Teflon (registered trademark), the adhesive film is acrylic, the removal of the adhesive film is performed by MEK or acetone, and the metal film is any one of Sn, Ni, Ag or Al.

In any of the first through fourth aspects, the transfer mold is produced by transfer through a mother mold from a master mold, the surface portion is Ni, and the peel-away film is NiO.

Further, in any of the first through fourth aspects, the surface portion is Ni, the peel-away film is any one of PVA, PET or PMMA, the insulating film is SiO₂, SOG or a resin, and the insulating film is formed by CVD or sputter.

In any one of the first through fourth aspects, the peeling of the central conductive film from the transfer mold is performed using any one of a UV sheet, a heat release sheet, a vacuum chuck or an electrostatic chuck.

Further, in any of the first through fourth aspects, the resist film is any one of a photoresist film, a thermal resist film or a gravure ink film, and the first electroplating and the second electroplating are copper plating.

A fifth aspect of the presently disclosed embodiment relates to a method for producing a coil element assembly using a transfer mold substrate and has a step of preparing a transfer mold substrate provided with a plurality of transfer molds having inverse coil element patterns respectively etched in surface portions thereof and of which at least the surface portions are made of metal, a step of forming a peel-away film and an insulating film on the surfaces of the plurality of transfer molds in a superimposed manner, a step of forming a resist film in an area having no inverse coil element patterns formed therein on the insulating film, a step of removing by etching the insulating film with the resist film as a mask, a step of after removing the resist film, filling up an area having the inverse coil element patterns formed therein and forming a central conductive film by first electroplating so as to slightly protrude above the insulating film, a step of integrally peeling the central conductive film from the plurality of transfer molds and taking out only the central conductive film, and a step of forming a surface conductive film by second electroplating with the taken-out central conductive film as a foundation, forming a bonding film covering the surface conductive film by third electroplating, and forming a coil element assembly comprised of the central conductive film, the surface conductive film, and the bonding film.

A sixth aspect of the presently disclosed embodiment relates to a method for producing a coil element assembly using a transfer mold substrate and has a step of preparing a transfer mold substrate provided with a plurality of transfer molds having inverse coil element patterns respectively etched in surface portions thereof and of which at least the surface portions are made of metal, a step of forming a peel-away film and an insulating film on the surfaces of the plurality of transfer molds in a superimposed manner, a step of forming a resist film in an area having no inverse coil element patterns formed therein on the insulating film, a step of removing by etching the insulating film with the resist film as a mask, a step of after removing the resist film, filling an area having the inverse coil element patterns formed therein and forming a central conductive film by first electroplating so as to remain in the insulating film, a step of after removing the insulating film, integrally peeling the central conductive film from the plurality of transfer molds and taking out only the central conductive film, and a step of forming a surface conductive film by second electroplating with the taken-out central conductive film as a foundation, forming a bonding film covering the surface conductive film by third electroplating, and forming a coil element assembly comprised of the central conductive film, the surface conductive film and the bonding film.

A seventh aspect of the presently disclosed embodiment relates to a method for producing a coil element assembly using a transfer mold substrate and has a step of preparing a transfer mold substrate provided with a plurality of transfer molds having inverse coil element patterns respectively etched in surface portions thereof and of which at least the surface portions are made of metal, a step of forming a peel-away film and an insulating film on the surfaces of the plurality of transfer molds in a superimposed manner, a step of forming a resist film in an area having no inverse coil element patterns formed therein on the insulating film, a step of removing by etching the insulating film with the resist film as a mask, a step of after removing the resist film, filling an area having the inverse coil element patterns formed therein and forming a central conductive film by first electroplating so as to remain in the transfer molds, a step of integrally peeling the central conductive film from the plurality of transfer molds and taking out only the central conductive film, and a step of forming a surface conductive film by second electroplating with the taken-out central conductive film as a foundation, forming a bonding film covering the surface conductive film by third electroplating, and forming a coil element assembly comprised of the central conductive film, the surface conductive film and the bonding film.

An eighth aspect of the presently disclosed embodiment relates to a method for producing a coil element assembly using a transfer mold substrate and has a step of preparing a transfer mold substrate provided with a plurality of transfer molds having inverse coil element patterns respectively etched in surface portions thereof and of which at least the surface portions are made of metal, a step of forming a peel-away film and an insulating film on the surfaces of the plurality of transfer molds in a superimposed manner, a step of forming a resist film in an area having no inverse coil element patterns formed therein on the insulating film, a step of removing by etching the insulating film with the resist film as a mask, a step of filling up an area having the inverse coil element patterns formed therein and forming a central conductive film by first electroplating so as to remain in the resist film, a step of after removing the resist film, integrally peeling the central conductive film from the plurality of transfer molds and taking out only the central conductive film, and a step of forming a surface conductive film by second electroplating with the taken-out central conductive film as a foundation, forming a bonding film covering the surface conductive film by third electroplating, and forming a coil element assembly comprised of the central conductive film, the surface conductive film and the bonding film.

In any of the fifth through eighth aspects, the first electroplating and the second electroplating are copper plating, the third electroplating is tin plating, and the plurality of transfer molds are arranged in a matrix form.

A ninth aspect of the presently disclosed embodiment relates to a method for producing a coil component using coil element assemblies and has a step of preparing a plurality of coil element assemblies manufactured by any of the fifth through eighth means, a step of laminating the plurality of coil element assemblies so that the corresponding the coil elements in the plurality of coil element assemblies are aligned with each other, heating and/or pressurizing the coil element assemblies to bond to each other, and connecting the coil elements in each layer to each other to form a coil, a step of exposing an electrode lead-out portion using an upper core and a lower core either of which having a protrusion portion extending through a central part of the coil, and sealing the coil, a step of filling an insulating material from a gap between the upper core and the lower core to fix the coil, and a step of cutting the laminated coil element assemblies in the coil units and attaching an external electrode to the electrode lead-out portion to form a coil component.

In the ninth aspect, the corresponding coil elements in the plurality of coil element assemblies include coil patterns different from each other.

### Advantageous Effect of the Invention

In the presently disclosed embodiment, since the peeling off from the transfer mold is done after the coil element and the coil element assembly are produced using the transfer mold, the insulating substrate for supporting the coil element and the coil element assembly is not required.

### BRIEF DESCRIPTION OF THE DRAWINGS

FIGS. 1A-1F are views showing a conduction process (pretreatment) for producing a coil element with plating.

FIGS. 2A-2D are views showing a process of producing a central conductive film by using a pre-processed mold (part 1).

FIGS. 3A-3D are views showing a process of producing a central conductive film by using a pre-processed mold (part 2).

FIGS. 4A-4F are views showing a process of producing a central conductive film by using a pre-processed mold (part 3).

FIGS. 5A-5E are views showing a process of producing a central conductive film by using a pre-processed mold (part 4).

FIGS. 6A-6B are views showing a cross-sectional shape of the produced central conductive film.

FIG. 7 is a view showing a cross-sectional shape of the central conductive film produced by first electroplating.

FIG. 8 is a view showing a cross-sectional shape of the central conductive film coated with a surface conductive film produced by second electroplating.

FIG. 9 is a view showing a cross-sectional shape of the conductive film after the second electroplating.

FIG. 10 is a view showing a cross-sectional shape of the conductor film after third electroplating.

FIG. 11 is a plan view of a coil element assembly produced by using a transfer mold substrate.

FIG. 12 is a view showing a state in which a plurality of coil element assemblies are laminated.

FIGS. 13A-13C are explanatory views for forming a coil by laminating a plurality of coil element assemblies and connecting coil elements of each layer to each other.

FIG. 14 is a view showing a state in which the coil is sealed using an upper core and a lower core.

FIG. 15 is a view showing a state in which the coil is filled in with an insulating material.

FIGS. 16A-16B are views showing dicing for cutting off the laminated coil element assemblies in coil units.

FIG. 17A-17D are views showing a process of mounting an external electrode to an electrode lead-out portion to form a coil component.

FIG. 18A-18C are views showing one example of a transfer mold substrate.

FIG. 19A-19E are views showing a producing process of a master mold.

FIG. 20A-20D are views showing a process of replicating a son mold by transfer via a mother mold from the master mold.

### DETAILED DESCRIPTION

The presently disclosed embodiment will hereinafter be described in detail in accordance with the accompanying drawings.

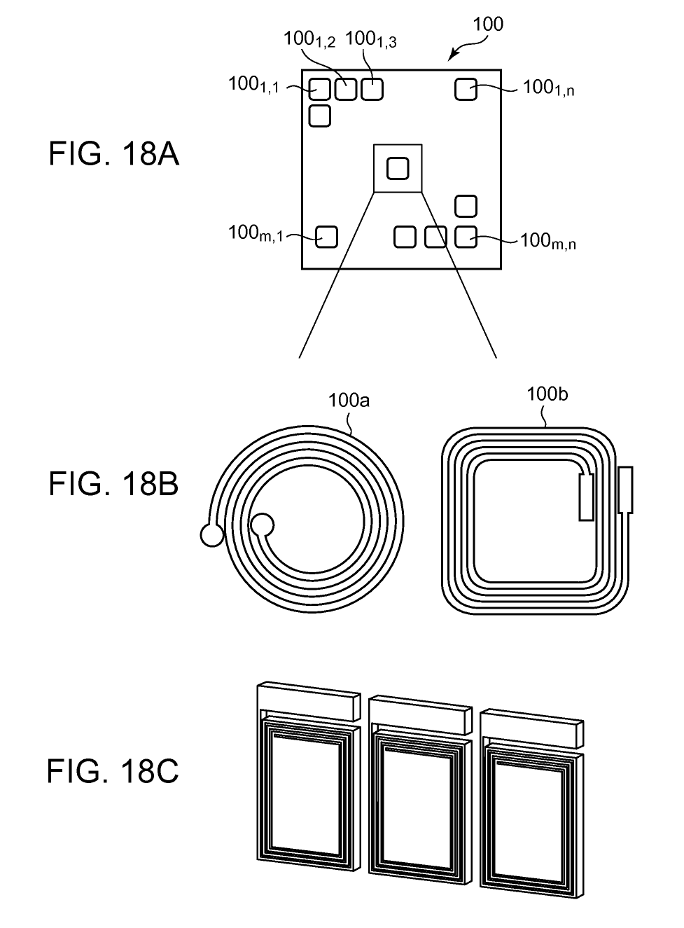

FIG. 18A-18C are views showing one example of a transfer mold substrate used in the presently disclosed embodiment.

The transfer mold substrate 100 is equipped with a plurality of transfer molds 100_{m, n} (where m, n=1, 2, as shown in FIG. 18A. These transfer molds 100_{m, n} are normally arranged in a matrix form. Further, these transfer molds 100_{m,n} are formed with coil element patterns 100a, 100b of such various shapes as shown in FIG. 18B etched thereon. The shapes of the coil element patterns 100a, 100b can be configured by combining straight lines or curved lines and designed to any shape by partially changing a line width.

These coil element patterns 100a, 100b are etched as inverse coil element patterns on the transfer mold substrate 100 by a known photolithography technique using a photomask. FIG. 18C is a typical view showing a part of a transfer mold substrate with inverse coil element patterns etched thereon. While the transfer mold substrate is provided with a plurality of transfer molds in this way, attention is focused on one transfer mold for convenience of explanation below, and its production method will be described. In general, while a transfer mold used in the manufacture of an actual element is called a working mold or a son mold, these working and son molds are produced by transfer from a master mold.

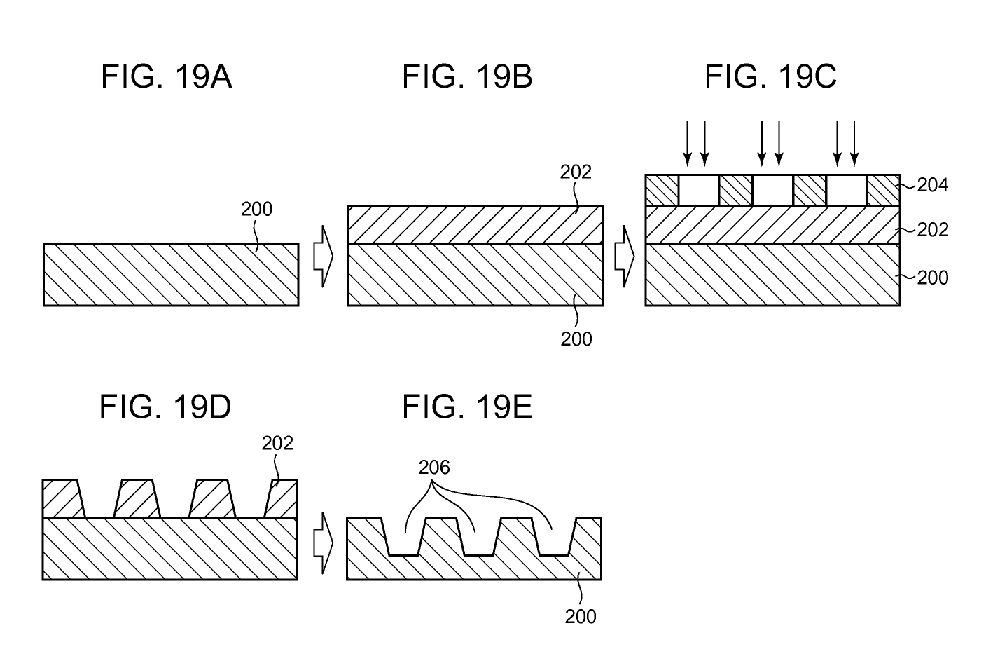

FIGS. 19A-19E is a view showing a manufacturing process of the master mold.

First, as shown in FIG. 19A, a master substrate 200 with Si (silicon), Ni (nickel) or the like as a material is prepared. Then, as shown in FIG. 19B, a photosensitive resist 202 such as a liquid resist, a dry film resist or the like is applied onto the surface thereof.

Incidentally, in the case of the liquid type resist, the adhesion of the resist 202 is improved when an adhering agent is undercoated before the application of the resist 202. Next, as shown in FIG. 19C, an element pattern is baked on the resist 202 by performing UV exposure through a photomask 204 formed with the element pattern. Then, the element pattern is formed as shown in FIG. 19D by developing the resist 202.

Next, the master substrate 200 is selectively etched using the known etching technique. Thereafter, the resist 202 is removed to thereby complete the master mold with an inverse element pattern 206 etched thereon as shown in FIG. 19E.

Incidentally, although the sidewall of the pattern is shown as inclined in FIG. 19E, the sidewall can be brought to a substantially vertical shape if a dry process is used in etching.

Here, since the manufactured master mold is expensive, it is left as an original mold, and a mother mold and a son mold are produced by transfer and replication from this master mold by using a plating technique.

The mother mold and the son mold are capable of normally several tens of replication.

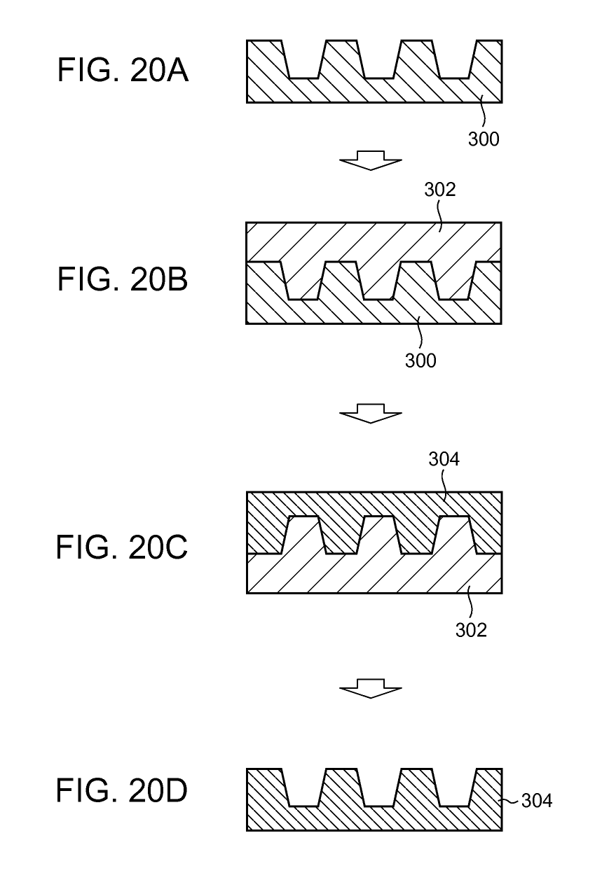

FIGS. 20A-20D is a view showing a process of replicating a son mold from a master mold by transfer through a mother mold.

First, a master mold 300 is prepared as shown in FIG. 20A. Then, as shown in FIG. 20B, a metal such as Ni is electrodeposited to the master mold 300 with a desired thickness using a plating technique. This is peeled from the master mold 300 to produce a mother mold 302. The master mold 300 and the mother mold 302 are reversed in pattern shape. Further, as shown in FIG. 20C, a metal such as Ni is electrodeposited to the mother mold 302. Thereafter, this is peeled from the mother mold 302 to produce a son mold 304 as shown in FIG. 20D. Since the mother mold 302 and the son mold 304 are reversed in pattern shape, the pattern shape of the son mold 304 becomes the same as that of the master mold 300.

The coil element will be produced below using this son mold 304 as a transfer mold.

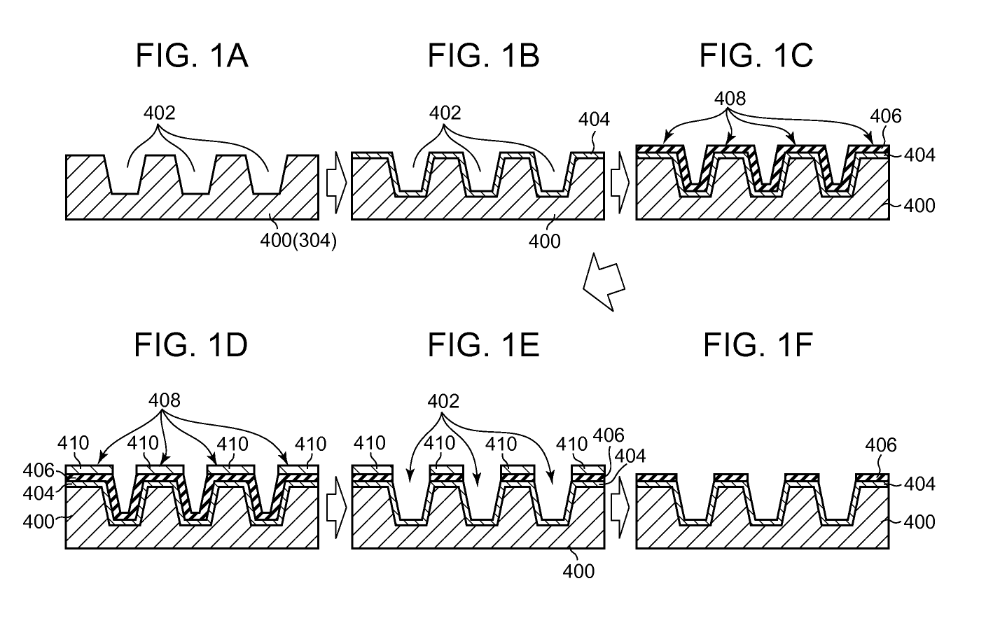

Although the coil element is manufactured by electroplating by using the transfer mold in the presently disclosed embodiment, there is a need to perform conduction processing on the transfer mold to perform electroplating. Here, while the conduction processing on the transfer mold is called pretreatment, FIGS. 1A-1F are views showing a pretreatment process.

First, the son mold 304 replicated in FIG. 20D is prepared as a transfer mold 400 as shown in FIG. 1A.

In this transfer mold 400, its surface portion is formed to be etched with an inverse coil element pattern 402. The entire transfer mold 400 may be made of metal. However, only its surface portion may be made of metal, and a base portion thereof may be a non-metallic material. Next, as shown in FIG. 1B, a peel-away film 404 is formed on the surface of the transfer mold 400. This is done to facilitate peeling of the metal electrodeposited to the inverse coil element pattern 402 by plating later. As the peel-away film 404, nickel oxide (NiO) is normally used where Ni (Nickel) is used as the material of the transfer mold 400.

This is because since NiO can be easily formed by thermally oxidizing Ni and has conductivity, it can be left on the surface of the transfer mold 400 as it is during electroplating.

Further, as the peel-away film 404, a non-conductive material film composed of a material softened or molten by heat such as PVA (polyvinyl alcohol), PET, PMMA (acrylic) or the like can be used.

In this case, in preparation for electrodeposition of a conductive film by the subsequent plating process, there is a need to form a metal thin film on the material layer of this non-conductive material film by copper or the like.

Next, as shown in FIG. 1C, an insulating film 406 is formed to be superimposed on the surface of the peel-away film 404. As the insulating film 406, SiO₂, SOG or a resin or the like is used.

CVD (Chemical Vapor Deposition) or sputter can be used in the formation of the insulating film 406. The insulating film 406 is left only in an area 408 unformed with the inverse coil element pattern to eliminate conductivity in a subsequent process and used to prevent plating from being electrodeposited in the area 408.

Next, as shown in FIG. 1D, a resist film 410 is formed in the area 408 on the insulating film 406, which is not formed with the inverse coil element pattern. As the resist film 410, a photoresist film, a heat resist film or a gravure ink film or the like can be used.

Upon the formation of the resist film 410, the resist film 410 can be applied only onto the area 408 by application using roll coating. Also, when it is difficult to apply the resist film 410 only to the area 408, it is applied on the entire surface. Thereafter, the resist film 410 may be etched using a photolithography technique to be left only in the area 408.

Next, as shown in FIG. 1E, the exposed insulating film 406 is removed by etching with the resist film 410 as a mask.

Thus, since only the area where the inverse coil element pattern 402 is formed becomes as having conductivity, a conductive film is electrodeposited by a subsequent plating process.

Thereafter, as shown in FIG. 1F, the resist film 410 is removed. The pretreatment process is ended in the above-described manner.

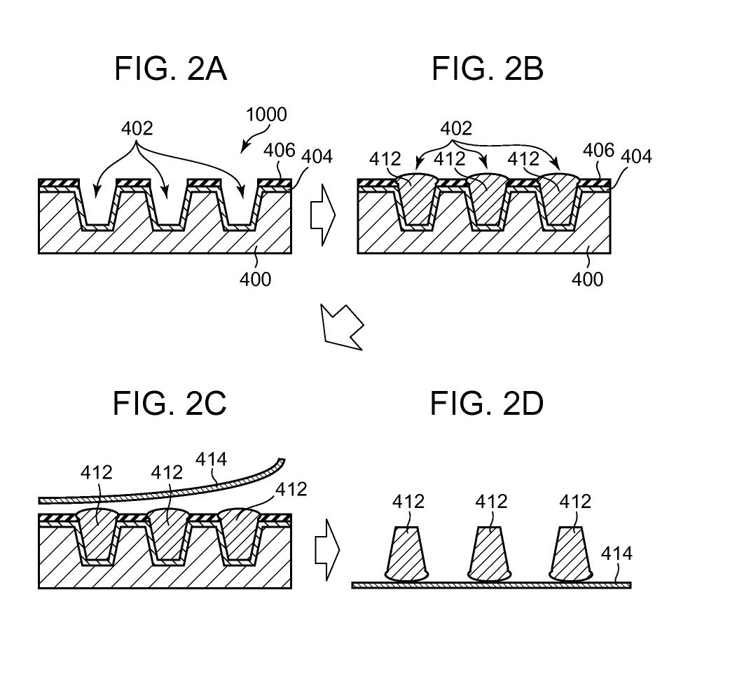

Next, a process of producing a central conductive film of a coil element using the pre-processed transfer mold will be described referring to FIGS. 2A-2D.

First, as shown in FIG. 2A, a pre-processed transfer mold 1000 (400) is prepared.

Then, as shown in FIG. 2B, the area formed with the inverse coil element pattern 402 is filled in by the first electroplating (electrolytic plating), and a central conductive film 412 is electrodeposited so as to project slightly above the insulating film 406. Although the first electroplating is normally copper plating, other metal materials may be plated.

Slightly projecting the central conductive film 412 above the insulating film 406 here is done to make it easy to bond an adhesive sheet or the like to the central conductive film 412 in the subsequent process. Further, when the central conductive film 412 is slightly projected above the insulating film 406, the end 413 of the central conductive film 412 is protruded so as to get on the insulating film 406 slightly.

Next, as shown in FIG. 2C, the central conductive film 412 is peeled from the transfer mold 1000 in a state of being adhered to an adhesive sheet 414 by affixing the adhesive sheet 414 to the entire surface of the central conductive film 412 and peeling it therefrom. Incidentally, when the central conductive film 412 is peeled from the transfer mold substrate equipped with a plurality of transfer modes, the central conductive film 412 is peeled from the plural transfer molds integrally. Instead of the adhesive sheet 414, a UV sheet or a heat release sheet can also be used for the separation of the central conductive film 412 from the transfer mold 1000. Further, this separation can also be performed using a vacuum chuck or an electrostatic chuck without using a release sheet.

Incidentally, when the above-described non-conductive material film is used as the peel-away film 404, the above material layer is softened or molten by heating before peeling from the transfer mold 1000. Therefore, adhesion between the central conductive film 412 and the transfer mold 1000 is relaxed so that the peeling-off of the central conductive film 412 therefrom becomes easy.

Thereafter, as shown in FIG. 2D, the adhesive sheet 414 is removed by heating or the like.

Incidentally, in order to, upon forming the central conductive film 412, eliminate the protrusion of the central conductive film 412 above the insulating film 406, provide the central conductive film as a rectangular central conductive film and peel the same from the transfer mold 400, there are such various methods as shown below.

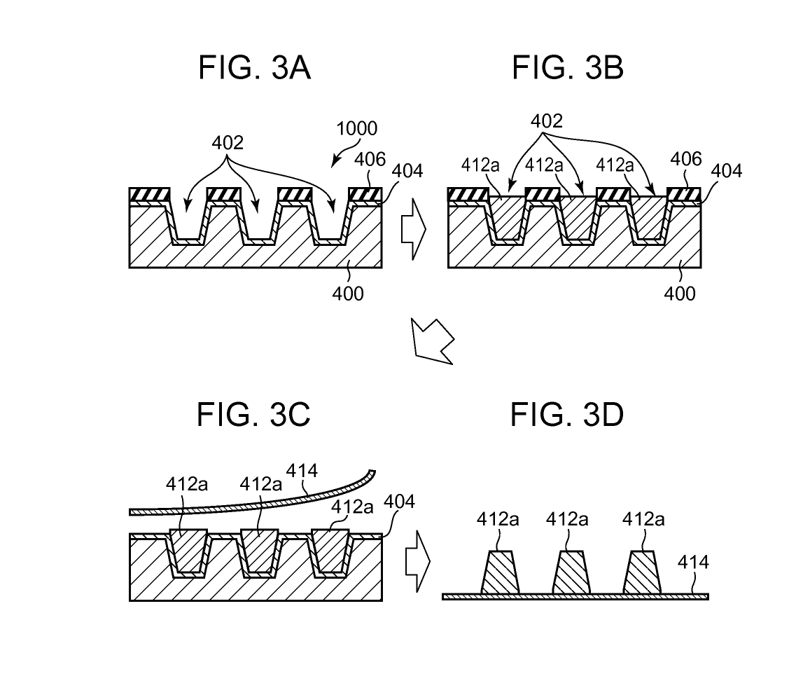

The first method is shown in FIGS. 3A-3D.

First, as shown in FIG. 3A, a pre-processed transfer mold 1000 (400) is prepared.

Then, as shown in FIG. 3B, an area formed with an inverse coil element pattern by first electroplating is filled in, and a central conductive film 412a is electrodeposited to remain in the insulating film 406.

By doing so, since the central conductive film 412a remains in the insulating film 406 and does not project upward, the shape of the central conductive film 412a becomes a flat rectangular shape at its upper surface.

Next, as shown in FIG. 3C, the insulating film 406 is removed by a method such as etching.

Then, the central conductive film 412a becomes a state in which the upper surface thereof is slightly projected upward from the upper surface of the peel-away film 404. Therefore, an adhesive sheet 414 is adhered to the upper surface of the central conductive film 412a and peeled off therefrom. Thereafter, as shown in FIG. 3D, the adhesive sheet 414 is removed.

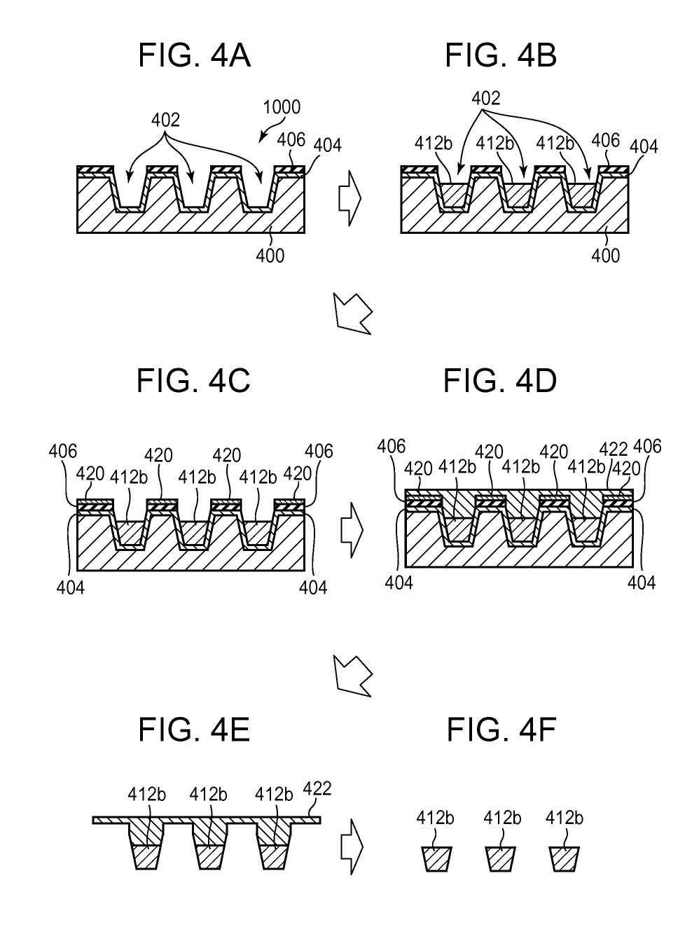

The second method is shown in FIGS. 4A-4F.

As with the first method, a pre-processed transfer mold 1000 (400) is prepared as shown in FIG. 4A. Then, as shown in FIG. 4B, an area formed with an inverse coil element pattern by first electroplating is filled in, and a central conductive film 412b is electrodeposited so as to remain in the transfer mold 400. By doing so, since the central conductive film 412b remains in the transfer mold 400 and is not projected upward, the shape of the central conductive film 412b takes a flat rectangular shape at its upper surface.

In this regard, the second method is similar to the first method, but becomes slightly smaller than the first method in terms of the aspect ratio of the coil element.

Then, as shown in FIG. 4C, a release agent such as silicone or Teflon is coated on the insulating film 406 to form a release agent film 420. The release agent film 420 is formed to prevent from becoming unable to peel by firmly bonding the adhesive film formed on the upper surface thereof in a subsequent process to the insulating film 406.

Next, as shown in FIG. 4D, an adhesive such as acrylic or the like is deposited so as to cover the exposed surface of central conductive film 412b and release agent film 420 to form an adhesive film 422. Thus, the central conductive film 412b is firmly bonded to the adhesive film 422.

In this state, as shown in FIG. 4E, the central conductive film 412b is peeled off from the transfer mold 400 together with the adhesive film 422. Thereafter, as shown in FIG. 4F, the adhesive film 422 is removed by being dissolved by an organic solvent such as MEK or acetone.

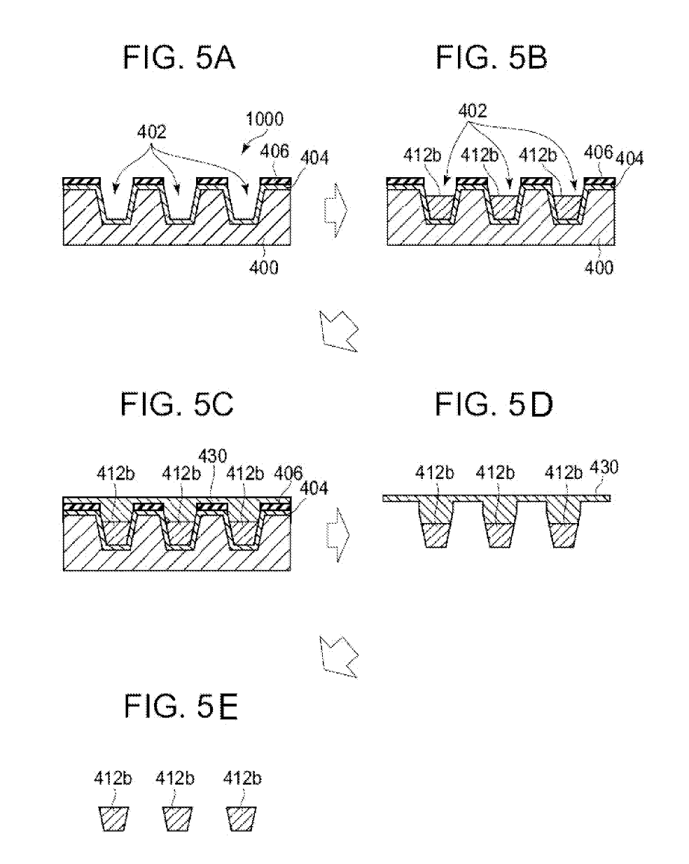

The third method is shown in FIGS. 5A-5E.

As shown in FIG. 5A and FIG. 5B, the third method is identical to the second method shown in FIG. 4A and FIG. 4B, up to the process of electrodepositing the central conductive film 412b to remain in the transfer mold 400.

Thereafter, as shown in FIG. 5C, a metal film 430 is deposited so as to cover the exposed surface of central conductive film 412b and insulating film 406. The adhesion of the metal film 430 can be performed by a method such as plating or sputter.

As the adhered metal film 430, a metal such as Sn, Ni, Ag or Al can be used. Preferably used is a metal which is good in adhesion to the central conductive film 412b and choice-etchable with respect to the metal of the central conductive film 412b.

Then, as shown in FIG. 5D, the central conductive film 412b is peeled off from the transfer mold 400 together with the metal film 430. Thereafter, as shown in FIG. 5E, the metal film 430 is removed by selective etching.

Although the fourth method is not illustrated in particular, the insulating film 406 is removed by etching as shown in FIG. 5E in the pretreatment process shown in FIGS. 1A-1F, followed by execution of the first electroplating shown in FIG. 2B while the resist film 410 remains adhered. Thereafter, the resist film 410 may be removed. According to this method, the aspect ratio of the coil element becomes high.

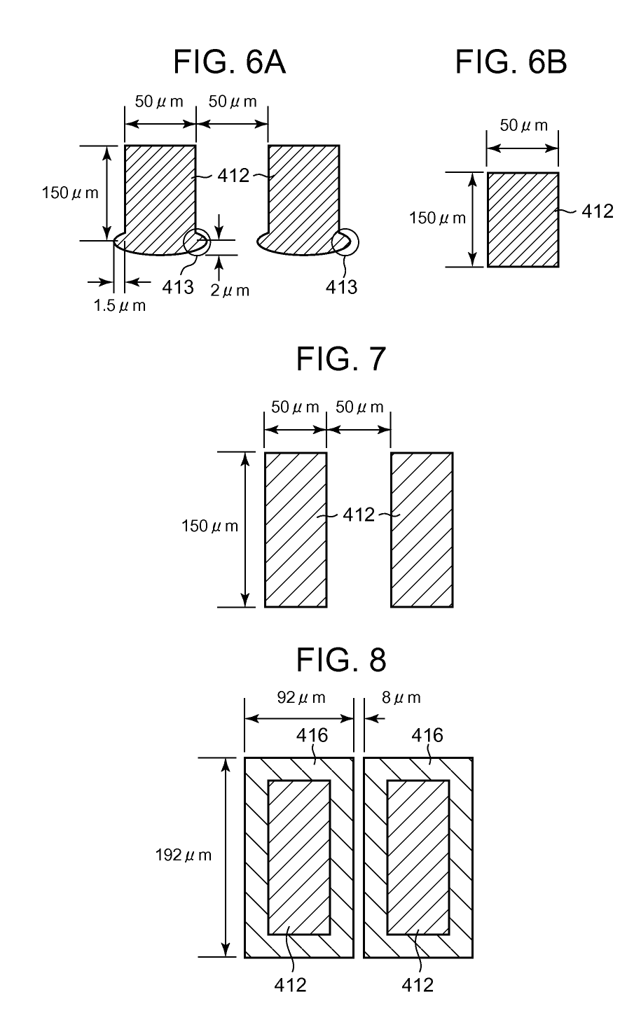

FIGS. 6A-6B are views showing a cross-sectional shape of the central conductive film 412 produced via the process of FIGS. 2A-2D. In the case of the present embodiment, as shown in FIG. 6A, the height (H) of the central conductive film 412 is 150 μm, the width (W) thereof is 50 μm, and the space between the central conductive films 412 is 50 μm. Further, the projection thereof onto the insulating film 406 was 2 μm, and the right-to-left expansion thereof was 1.5 μm.

Since the expansion of the end 413 of this central conductive film 412 causes an obstacle in uniform formation of the surface conductive film in a subsequent process, it is removed by electrolytic reverse plating treatment.

Incidentally, the electrolytic reverse plating treatment refers to treatment for making an electric field direction reverse and removing a plated metal by reverse etching. Here, since the electric field concentrates on the end 413 as compared with other portions, the etching rate increases and etching is selectively performed.

As a result, as shown in FIG. 6B, the central conductive film 412 of uniform shape is formed.

In the presently disclosed embodiment, then, the central conductive film 412 is made thick uniformly and the interconductor space is narrowed. FIG. 7 shows a cross-sectional shape of the central conductive film 412 produced by first plating treatment. In this embodiment, the height (H) is 150 μm, the width (W) is 50 μm, and the conductor space is 50 μm.

A surface conductive film 416 is formed so as to uniformly cover this central conductive film 412 by second electroplating with such a central conductive film 412 as a foundation. This is called thickening plating. In the case of the present embodiment, this thickening plating is also copper plating as with the first electroplating.

FIG. 8 is a view showing a cross-sectional shape of the central conductive film 412 coated with the surface conductive film 416 produced by the second electroplating (thickening plating).

When the periphery of the central conductive film 412 is given second electroplating treatment to take a thickness of 21 μm as a whole, the height (H) of the conductive film becomes 192 μm, the width (W) thereof becomes 92 μm, and the conductor space becomes 8 μm. A coil element is formed which is capable of handling a high rated current at a high aspect.

In the above description, the case where one coil element is produced by focusing on one transfer mold has been described. When, however, coil element assemblies having a plurality of coil elements are produced at a batch, they can be produced similarly by using a transfer mold substrate provided with a plurality of transfer molds respectively etched with inverse coil element patterns.

Next, a method for producing a coil component by using the so-produced coil element assemblies will be described. As will be described later, the coil component is produced by laminating a plurality of the coil element assemblies.

Therefore, there is a need to form a bonding film around the coil elements in advance in order to bond and connect the coil elements in each layer to each other.

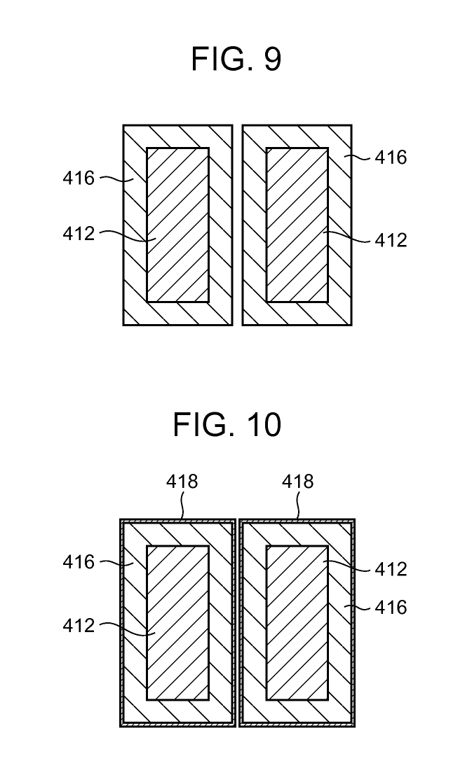

Therefore, a bonding film 418 is formed by third electroplating as shown in FIG. 10 around the conductor film comprised of the central conductive film 412 and the surface conductive film 416 after the second electroplating shown in FIG. 9. This bonding film 418 is normally formed by tin plating, and its thickness is taken to be about 2 μm.

Incidentally, when there is a fear that the conductor space becomes extremely narrow by the third electroplating, the thickness of the surface conductive film 416 in the second plating may be slightly reduced.

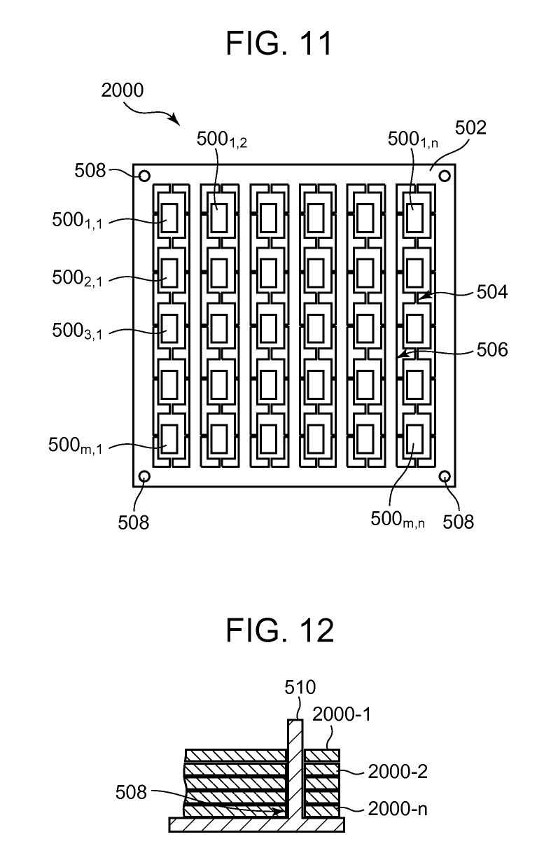

FIG. 11 is a plan view of a coil element assembly 2000 produced by using a transfer mold substrate. The transfer mold substrate for producing this coil element assembly 2000 is also the same shape as this shape. In order to reinforce conductive patters of a plurality of coil elements 500m, n (where m, n=1, 2 . . . ), there are provided a rib 502, gates 504 and runners 506. Further, holes 508 are provided in the four corners of the rib 502. The conductive patterns of the coil elements 500m, n formed in each layer of the plurality of coil element assemblies 2000 are aligned in position using pins 510 which extend through the holes 508.

As shown in FIG. 12, a plurality of coil element assemblies 2000-1, 2000-2, . . . 2000-N are laminated such that corresponding coil elements in the respective coil element assemblies are aligned with each other through the pins 510, and heated and/or pressurized to be joined to each other. The coil elements of the respective layers are connected to each other to form a coil. By heating and/or pressurizing, the tin plating that configures the bonding film 418 shown in FIG. 10 is molten and thereby acts as solder, so that the coil elements in each layer are bonded to each other.

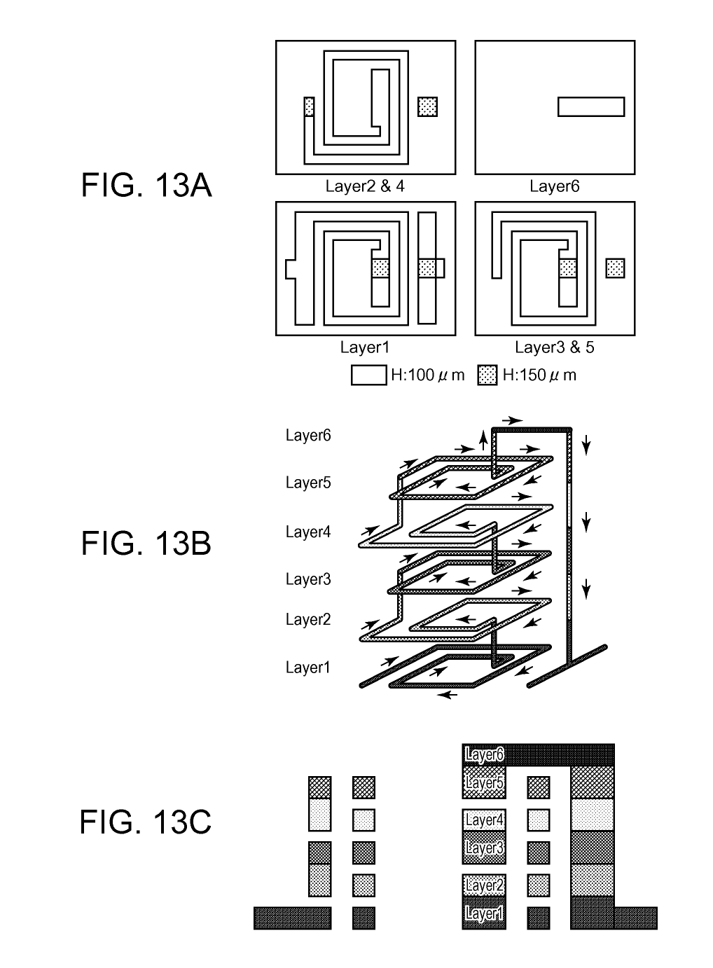

FIGS. 13A-13C are views for describing that a plurality of coil element assemblies are laminated and coil elements in each layer are connected to each other to form a coil. The embodiment shown in FIG. 13 shows the case where coil element assemblies of six layers are laminated over each other and coil elements in each layer are connected to each other to produce one coil. The corresponding coil elements in the plurality of coil element assemblies can be configured to include coil patterns different from each other.

In the examples shown in FIGS. 13A-13C, the first layer (Layer 1), the third layer (Layer 3), and the sixth layer (Layer 6) respectively become coil patterns different from each other. The second layer (Layer 2) and the fourth layer (Layer 4) respectively become the same coil pattern, and the third layer (Layer 3) and the fifth layer (Layer 5) respectively become the same coil pattern. FIG. 13B and FIG. 13C respectively show a state in which the coil element assemblies of six layers are laminated over each other and the corresponding coil elements in each layer are joined to each other so as to be aligned with each other, and the coil elements are connected to each other to form one coil.

Incidentally, although the heights (H) of the central conductive layers that configure the coil elements have been described in such an image as to be arranged upon the production of the coil elements in the aforementioned description, there are actually used those different in height at the connecting portions of the respective layers as shown in FIG. 13A. In the example shown in FIG. 13A, the height (H) is 100 μm in the pattern of a normal coil element, but 150 μm at an interlayer connection portion.

The production of such coil patterns different in height (H) in the same layer can be realized by deepening the depth of each etching pattern formed in the transfer mold at the connecting portion, and performing filling plating on the deepened portions selectively or performing copper plating thereon using a mask twice by using a special copper plating solution for field via.

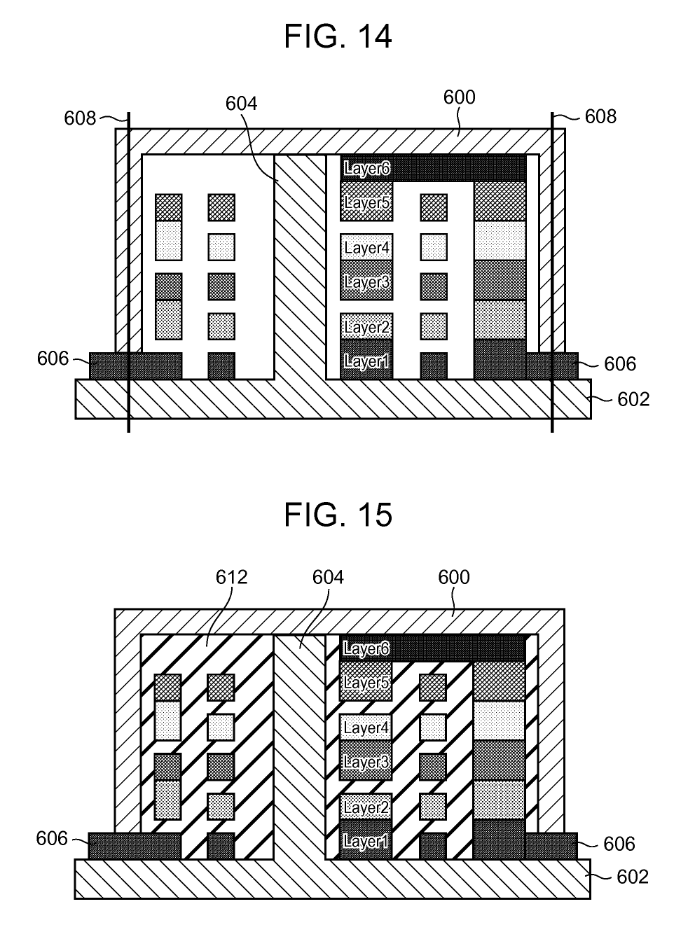

After the coil is formed by connecting the coil elements in each layer to each other in the above-described manner, as shown in FIG. 14, an electrode lead-out portion 606 is exposed outside to seal the coil, using an upper core 600 and a lower core 602 each being a magnetic body, either of which having a protrusion portion 604 extending through the center of the coil. At this time, the upper core 600 and the lower core 602 are attached so as to avoid each gate 504 for pattern reinforcement shown in FIG. 11. Incidentally, the upper core 600 and the lower core 602 are cut along dicing lines 608 in a subsequent dicing process. Then, as shown in FIG. 15, an insulating material 612 is filled from a gap (not shown) between the upper core 600 and the lower core 602 to fix the coil.

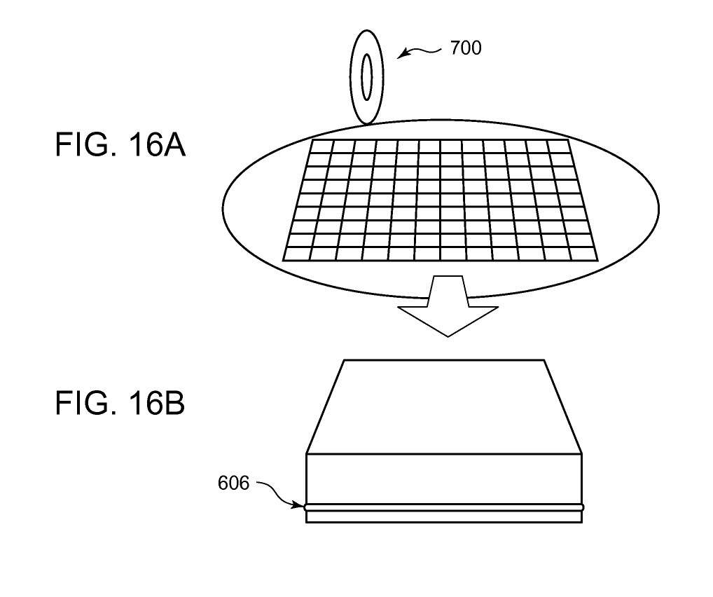

Then, the coil element assemblies laminated as shown in FIGS. 16A-16B are cut in coil units using a cutter 700. FIG. 16A shows a coil element assembly, and FIG. 16B shows one coil component. The electrode lead-out portion 606 is formed as part of the first layer (Layer 1).

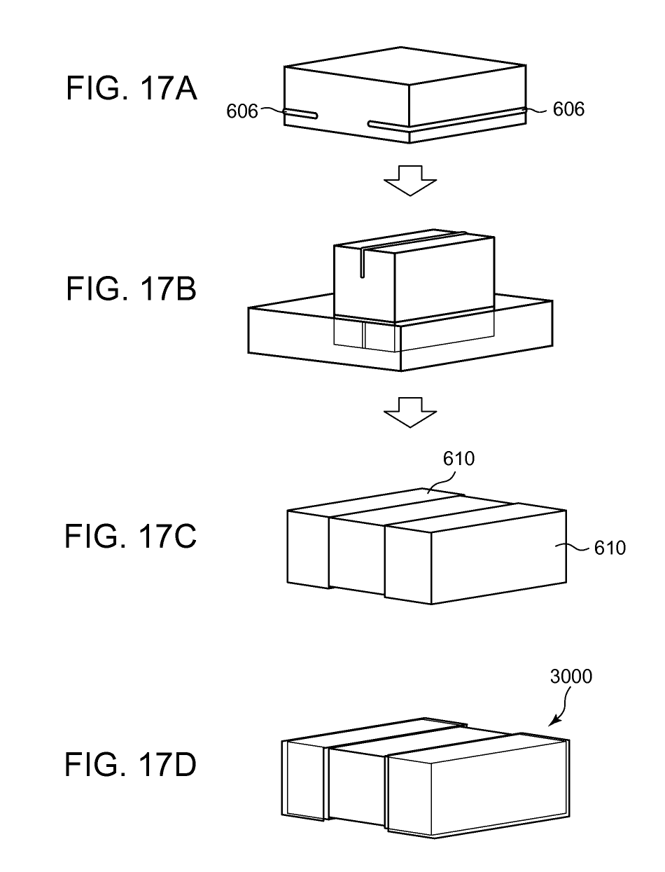

Finally, as shown in FIGS. 17A-17D, an external electrode 610 is attached to the electrode lead-out portion 606 by a method such as a solder dip method, and pre-soldering is performed as a pretreatment for subsequent soldering to complete a coil component 3000.

### DESCRIPTION OF REFERENCE NUMERALS

200: master substrate
202: resist
206: inverse element pattern
300: master mold
302: mother mold
304: son mold
400: transfer mold
402: inverse coil element pattern
404: peel-away film
406: insulating film
408: area unformed with inverse coil element pattern
410: resist film
412: central conductive film
413: end of central conductive film
416: surface conductive film
418: bonding film
600: upper core
602: lower core
604: protrusion portion
606: electrode lead-out portion
608: dicing line
610: external electrode
1000: pre-processed transfer mold
2000: coil element assembly
3000: coil component.

What is claimed is:

1. A method for producing a coil element using a transfer mold of which at least a surface portion is made of metal, comprising the steps of:
preparing the transfer mold having an inverse coil element pattern etched in the surface portion;
forming a peel-away film and an insulating film on the surface of the transfer mold in a superimposed manner;
forming a resist film in an area having no inverse coil element pattern formed therein on the insulating film;
removing by etching the insulating film with the resist film as a mask;
after removing the resist film, filling up an area having the inverse coil element pattern formed therein and forming a central conductive film by first electroplating so as to slightly protrude above the insulating film;
peeling the central conductive film from the transfer mold and taking out only the central conductive film; and
forming a surface conductive film by second electroplating with the taken-out central conductive film as a foundation and forming a coil element comprised of the central conductive film and the surface conductive film.

2. A method for producing a coil element using a transfer mold of which at least a surface portion is made of metal, comprising the steps of:
preparing the transfer mold having an inverse coil element pattern etched in the surface portion;
forming a peel-away film and an insulating film on the surface of the transfer mold in a superimposed manner;
forming a resist film in an area having no inverse coil element pattern formed therein on the insulting film;
removing by etching the insulating film with the resist film as a mask;
after removing the resist film, filling an area having the inverse coil element pattern formed therein and forming a central conductive film by first electroplating so as to remain in the insulating film;
after removing the insulating film, peeling the central conductive film from the transfer mold and taking out only the central conductive film; and
forming a surface conductive film by second electroplating with the taken-out central conductive film as a foundation and forming a coil element comprised of the central conductive film and the surface conductive film.

3. A method for producing a coil element using a transfer mold of which at least a surface portion is made of metal, comprising the steps of:
preparing the transfer mold having an inverse coil element pattern etched in the surface portion;
forming a peel-away film and an insulating film on the surface of the transfer mold in a superimposed manner;
forming a resist film in an area having no inverse coil element pattern formed therein on the insulating film;
removing by etching the insulating film with the resist film as a mask;
after removing the resist film, filling an area having the inverse coil element pattern formed therein and forming a central conductive film by first electroplating so as to remain in the transfer mold;
peeling the central conductive film from the transfer mold and taking out only the central conductive film; and
forming a surface conductive film by second electroplating with the taken-out central conductive film as a foundation and forming a coil element comprised of the central conductive film and the surface conductive film.

4. A method for producing a coil element using a transfer mold of which at least a surface portion is made of metal, comprising the steps of:
preparing the transfer mold having an inverse coil element pattern etched in the surface portion;
forming a peel-away film and an insulating film on the surface of the transfer mold in a superimposed manner;
forming a resist film in an area having no inverse coil element pattern formed therein on the insulating film;
removing by etching the insulating film with the resist film as a mask;
filling up an area having the inverse coil element pattern formed therein and forming a central conductive film by first electroplating so as to remain in the resist film;
after removing the resist film, peeling the central conductive film from the transfer mold and taking out only the central conductive film; and
forming a surface conductive film by second electroplating with the taken-out central conductive film as a foundation and forming a coil element comprised of the central conductive film and the surface conductive film.

5. The method according to claim 1, wherein the end of the central conductive film, which slightly protrudes above the insulating film, is removed by electrolytic reverse plating treatment.

6. The method according to claim 3, wherein the peeling of the central conductive film from the transfer mold is performed by:
forming a release agent film on the insulating film,
depositing an adhesive film so as to cover the exposed surface of the central conductive film and the release agent film, and peeling the central conductive film from the transfer mold together with the adhesive film, and
thereafter removing the adhesive film.

7. The method according to claim 3, wherein the peeling of the central conducive film from the transfer mold is performed by depositing a metal film so as to cover the exposed surface of the central conductive film and the insulating film and peeling the central conductive film from the transfer mold together with the metal film, and thereafter removing the metal film.

8. The method according to claim 6, wherein the release agent film is silicone or Teflon.

9. The method according to claim 6, wherein the adhesive film is acrylic, and the removal of the adhesive film is performed by MEK or acetone.

10. The method according to claim 7, wherein the metal film is any one of Sn, Ni, Ag or Al.

11. The method according to claim 1, wherein the transfer mold is produced by transfer through a mother mold from a master mold.

12. (canceled)

13. The method according to claim 1, wherein the surface portion is Ni, and the peel-away film is NiO.

14. The method according to claim 1, wherein the surface portion is Ni, and the peel-away film is any one of PVA, PET or PMMA.

15. The method according to claim 1, wherein the insulating film is SiO₂, SOG or a resin.

16. The method according to claim 1, wherein the insulating film is formed by CVD or sputter.

17. The method according to claim 1, wherein the peeling of the central conductive film from the transfer mold is performed using any one of a UV sheet, a heat release sheet, a vacuum chuck or an electrostatic chuck.

18. The method according to claim 1, wherein the resist film is any one of a photoresist film, a thermal resist film or a gravure ink film.

19. The method according to claim 1, wherein the first electroplating and the second electroplating are copper plating.

20. A method for producing a coil element assembly using a transfer mold substrate, comprising the steps of:
preparing a transfer mold substrate provided with a plurality of transfer molds having inverse coil element patterns respectively etched in surface portions thereof and of which at least the surface portions are made of metal;
forming a peel-away film and an insulating film on the surfaces of the plurality of transfer molds in a superimposed manner;
forming a resist film in an area having no inverse coil element patterns formed therein on the insulating film;
removing by etching the insulating film with the resist film as a mask;
after removing the resist film, filling up an area having the inverse coil element patterns formed therein and forming a central conductive film by first electroplating so as to slightly protrude above the insulating film;
integrally peeling the central conductive film from the plurality of transfer molds and taking out only the central conductive film; and
forming a surface conductive film by second electroplating with the taken-out central conductive film as a foundation, forming a bonding film covering the surface conductive film by third electroplating, and forming a coil element assembly comprised of the central conductive film, the surface conductive film, and the bonding film.

21. A method for producing a coil element assembly using a transfer mold substrate, comprising the steps of:
preparing a transfer mold substrate provided with a plurality of transfer molds having inverse coil element patterns respectively etched in surface portions thereof and of which at least the surface portions are made of metal;
forming a peel-away film and an insulating film on the surfaces of the plurality of transfer molds in a superimposed manner;
forming a resist film in an area having no inverse coil element patterns formed therein on the insulating film;
removing by etching the insulating film with the resist film as a mask;
after removing the resist film, filling an area having the inverse coil element patterns formed therein and forming a central conductive film by first electroplating so as to remain in the insulating film;
after removing the insulating film, integrally peeling the central conductive film from the plurality of transfer molds and taking out only the central conductive film; and
forming a surface conductive film by second electroplating with the taken-out central conductive film as a foundation, forming a bonding film covering the surface conductive film by third electroplating, and forming a coil element assembly comprised of the central conductive film, the surface conductive film and the bonding film.

22. A method for producing a coil element assembly using a transfer mold substrate, comprising the steps of:
preparing a transfer mold substrate provided with a plurality of transfer molds having inverse coil element patterns respectively etched in surface portions thereof and of which at least the surface; portions are made of metal;
forming a peel-away film and an insulating film on the surfaces of the plurality of transfer molds in a superimposed manner;
forming a resist film in an area having no inverse coil element patterns formed therein on the insulating film;
removing by etching the insulating film with the resist film as a mask;
after removing the resist film, filling an area having the inverse coil element patterns formed therein and forming a central conductive film by first electroplating so as to remain in the transfer molds;
integrally peeling the central conductive film from the plurality of transfer molds and taking out only the central conductive film; and
forming a surface conductive film by second electroplating with the taken-out central conductive film as a foundation, forming a bonding film covering the surface conductive film by third electroplating, and forming a coil element assembly comprised of the central conductive film, the surface conductive film and the bonding film.

23. A method for producing a coil element assembly using a transfer mold substrate, comprising the steps of:
preparing a transfer mold substrate provided with a plurality of transfer molds having inverse coil element patterns respectively etched in surface portions thereof and of which at least the surface portions are made of metal;
forming a peel-away film and an insulating film on the surfaces of the plurality of transfer molds in a superimposed manner;
forming a resist film in an area having no inverse coil element patterns formed therein on the insulating film;
removing by etching the insulating film with the resist film as a mask;
filling up an area having the inverse coil element patterns formed therein and forming a central conductive film by first electroplating so as to remain in the resist film;
after removing the resist film, integrally peeling the central conductive film from the plurality of transfer molds and taking out only the central conductive film; and
forming a surface conductive film by second electroplating with the taken-out central conductive film as a foundation, forming a bonding film covering the surface conductive film by third electroplating, and forming a coil element assembly comprised of the central conductive film, the surface conductive film and the bonding film.

24. The method according claim 20, wherein the first electroplating and the second electroplating are copper plating, and the third electroplating is tin plating.

25. The method according claim 20, wherein the plurality of transfer molds are arranged in a matrix form.

26. A method for producing a coil component using coil element assemblies, comprising the steps of:
preparing a plurality of coil element assemblies manufactured by the method according to any of claims 20 to 25;
laminating the plurality of coil element assemblies so that the corresponding coil elements in the plurality of coil element assemblies are aligned with each other, heating and/or pressurizing the coil element assemblies to bond to each other, and connecting the coil elements in each layer to each other to form a coil;
exposing an electrode lead-out portion using an upper core and a lower core either of which having a protrusion portion extending through a central part of the coil, and sealing the coil;
filling an insulating material from a gap between the upper core and the lower core to fix the coil; and
cutting the laminated coil element assemblies in the coil units and attaching an external electrode to the electrode lead-out portion to form a coil component.

27. The method according to claim 26, wherein the corresponding coil elements in the plurality of coil element assemblies include coil patterns different from each other.
